(19) United States
(12) Patent Application Publication
(10) Pub. No.: US 2004/0086167 A1
(43) Pub. Date: May 6, 2004

(54) Method and apparatus for analyzing a sample employing fast fourier transformation

(76) Inventors: Chung-Sam Jun, Suwon-si (KR); Sang-Mun Chon, Yongin-si (KR); Sun-Yong Choi, Seongnam-si (KR); Dong-Jin Park, Hwaseong-gun (KR); Jeong-Hyun Choi, Yongin-si (KR)

Correspondence Address: LEE & STERBA, P.C., Suite 2000, 1101 Wilson Boulevard, Arlington, VA, 22209, US

(21) Appl. No.: 10/661,632

(22) Filed: Sep. 15, 2003

(30) Foreign Application Priority Data
Oct. 30, 2002 (KR) 2002-66614

(51) Int. Cl. G06K 9/00; G06K 9/36

(52) U.S. Cl. 382/141; 382/280

(57) ABSTRACT

A method and an apparatus for analyzing a portion of a sample, such as a minute pattern formed on a semiconductor substrate, by employing a Fast Fourier Transformation (FFT) method, in which a magnified image of a region of a sample to be analyzed is generated and converted into data having a frequency by the FFT method. The converted data are analyzed to determine whether the region of the sample is normal or abnormal. It is possible to measure and analyze the sample simultaneously and automatically by using the apparatus in accordance with the method for analyzing the sample.

### BACKGROUND OF THE INVENTION

1. Field of the Invention

The present invention relates to a method and an apparatus for analyzing a sample by employing a Fast Fourier Transformation (FFT) technique. More particularly, the present invention relates to a method and an apparatus for analyzing a minute pattern on a substrate by employing a FFT technique.

2. Description of the Related Art

Due in part to the rapid development of the information society, semiconductor devices are required to have a rapid processing speed and a large storage capacity to allow rapid treatment of large quantities of information. Thus, semiconductor device manufacturing technology has also been developing rapidly to provide improved integration density and enhanced the response speeds in semiconductor devices.

Meanwhile, the yield of the semiconductor device manufacturing processes becomes more important as semiconductor device manufacturing technology develops. Thus, failures that are directly related to the yield are thoroughly controlled in semiconductor device manufacturing processes. During unit processes for manufacturing semiconductor devices, the unit processes are appraised by using analysis apparatuses such as transmission electron microscopes or scanning electron microscopes.

A scanning electron microscope is mainly utilized for magnifying an image of a minute pattern. The line width of the minute pattern is measured from the magnified image of the minute pattern. The presence of any abnormalities in the minute pattern may also be discerned from the magnified image. Generally, an additional apparatus for measuring the line width is used to measure the line width of the minute pattern, while variations in the pattern are identified with a naked eye of an operator. After the image of the minute pattern is enlarged with high magnification by the scanning electron microscope, the operator identifies whether the minute pattern is normal or abnormal by observing the magnified image. At the same time, the line width of the minute pattern is measured with the additional apparatus.

Recently, in an integrated apparatus used in automated manufacturing lines a scanning electron microscope is integrated with the apparatus for measuring the line width of the pattern. Hence, the line width of the minute pattern can be automatically measured from the image of the minute pattern magnified with the scanning electron microscope. However, because the abnormal or normal pattern is mainly identified with the naked eye of the operator, the integrated apparatus cannot identify whether the minute pattern is normal or abnormal. As a result, the integrated apparatus may be employed to measure the line width of the pattern only.

### SUMMARY OF THE INVENTION

The present invention has been made in an effort to solve the aforementioned problems and accordingly, it is a first feature of an embodiment of the present invention to provide a method for automatically determining whether a region of a sample to be analyzed is normal or abnormal.

It is a second feature of an embodiment of the present invention to provide a method for measuring the line width of a minute pattern and for simultaneously determining whether the minute pattern is normal or abnormal.

It is a third feature of an embodiment of the present invention to provide an apparatus for automatically determining whether the region of a sample to be analyzed is normal or abnormal.

It is a fourth feature of an embodiment of the present invention to provide an apparatus for measuring the line width of a minute pattern, and for simultaneously determining whether the minute pattern is normal or abnormal.

In an effort to provide the first feature of the present invention, a method for analyzing a sample by employing a Fast Fourier Transformation (FFT) method of one preferred embodiment of the present invention includes generating an image of a region of the sample to be analyzed, generating data having a frequency from the image by the FFT method, and analyzing the generated data to determine whether the region is normal or abnormal.

In the method described above, the region may include a periodically formed pattern, or the region may be formed on a semiconductor substrate and may correspond to a cell region including a periodic pattern. The periodic pattern may have a line width and may be formed by an etching process. The image may be generated by a scanning electron microscope, and may be defined into at least two pixel units. Finally, an alarm is preferably provided when it is determined that the region is abnormal.

In an effort to provide the second feature of the present invention, a method for analyzing a sample by employing a FFT method of another preferred embodiment of the present invention includes generating a magnified image of a minute pattern formed in a cell region of a semiconductor substrate, measuring a line width of the minute pattern using the magnified image, generating data having a frequency from the image by the Fast Fourier Transformation method, and analyzing the generated data to determine whether the minute pattern is normal or abnormal.

In an effort to provide the third feature of the present invention, according to a preferred embodiment, the apparatus for analyzing a sample by employing a FFT method includes an image generation part for generating an image of a region of the sample to be analyzed, a data generation part for generating data having a frequency from the image by the Fast Fourier Transformation method, and a data discrimination part for analyzing the generated data to determine whether the region is normal or abnormal. The apparatus may further include a display part for displaying the generated data, and an alarm part for providing an alarm when the region is abnormal. The image generation part preferably includes a scanning electron microscope.

In an effort to provide the fourth feature of the present invention, according to a preferred embodiment, the apparatus for analyzing a sample by employing a FFT method includes a scanning electron microscope for generating a magnified image of a minute pattern formed in a cell region of a semiconductor substrate, a line width measurement part for measuring a line width of the minute pattern using the magnified image, a data generation part for generating data having a frequency from the magnified image by the Fast Fourier Transformation method, and a data discrimination part for analyzing the generated data to determine whether the minute pattern is normal or abnormal.

According to the present invention, the image of the region of the sample to be analyzed may be generated as data having a frequency by employing the FFT method. Thus, an abnormal or normal region of the sample can be determined by analyzing the data with the automatically constructed apparatus and method for analyzing the sample. In particular, when the minute pattern formed on the semiconductor substrate is analyzed in accordance with the apparatus and method of the present invention, the line width of the minute pattern can be measured while the minute pattern is simultaneously analyzed for abnormalities.

The method and apparatus of the present invention may be advantageously employed in recent automated manufacturing lines. Particularly, the method and the apparatus of the present invention may be effectively employed for large substrates having a diameter of about 300 mm, which cannot be easily handled by an operator. Further, the automated manufacturing lines may be set up with respect to the large substrate.

### BRIEF DESCRIPTION OF THE DRAWINGS

The above features and advantages of the present invention will become more apparent to those of ordinary skill in the art by describing in detail preferred embodiments thereof with reference to the attached drawings in which:

FIG. 1 is a block diagram illustrating an apparatus for analyzing a sample according to a preferred embodiment of the present invention;

FIG. 2 is a flow chart illustrating the method for analyzing a sample according to a preferred embodiment of the present invention;

FIG. 3 illustrates a plane view showing a minute pattern included in a sample for analysis according to a preferred embodiment of the present invention; and

FIG. 4 is a graph illustrating power spectrums relative to frequency taken along the lines of ‘A’, ‘B’, and ‘C’ in FIG. 3.

### DESCRIPTION OF THE PREFERRED EMBODIMENT

Korean Patent Application No. 2002-66614 filed on Oct. 30, 2002, and entitled: “Method For and Apparatus For Analyzing a Sample Employing Fast Fourier Transformation Method” is incorporated by reference herein in its entirety.

The present invention will be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art.

First, an image of a region of a sample to be analyzed is generated. The image of the region to be analyzed is preferably enlarged with high magnifications. Thus, a scanning electron microscope is preferably employed to generate the magnified image of the region to be analyzed. When the region to be analyzed does not include a predetermined pattern, for example, an un-periodically formed pattern, the FFT technique may not be easily employed for analyzing the region. Therefore, the region to be analyzed preferably includes a periodic pattern such as a line shaped pattern including constant intervals, or a pattern having periodic recesses. In a case of a semiconductor device, a line shaped pattern corresponds to a metal wiring or a gate electrode line, and a pattern having periodic recesses corresponds to a pattern including a contact hole or a via hole. Hence, a region to be analyzed corresponds to a cell region of a semiconductor substrate. The periodic pattern is preferably formed through an etching process such that after the etching process, a pattern can be beneficially analyzed for abnormalities in accordance with the method of the present invention.

Then, frequency-domain data are generated from the magnified image of the region to be analyzed by employing a Fast Fourier Transformation (FFT) technique. The FFT technique is a well-known method by which time-domain data is converted into frequency domain data. In particular, in a video signal like an image, a space domain can be converted to the frequency domain by the FFT method. In the present invention, the space domain of the region to be analyzed is converted to the frequency domain by employing the FFT method. As a result, the image of the region can be converted into data having a frequency through the FFT method. The FFT method can be achieved in two dimensions since the FFT method is performed concerning the space domain like the region to be analyzed. Namely, the FFT method is executed concerning the region in an X-axis direction and a Y-axis direction. After the image of the region is preferably defined as at least two pixel units, the FFT method is performed concerning each pixel unit.

Subsequently, after the data obtained through the Fast Fourier Transformation method are analyzed, it is determined whether the region is normal or abnormal. Here, the obtained data are indicated as a graph. When the obtained data are represented as a graph, an abnormal or normal region is identified by the existence of an abnormal peak. If an abnormal peak exists, an alarm is given to an operator. Thus, after the operator identifies whether the region is normal or abnormal, the operator can take pertinent action to rectify any problem caused by an abnormal region.

The analysis apparatus for performing the method described above will now be described.

The analysis apparatus includes an image generation part for generating an image of a sample to be analyzed. The image generation part may include a scanning electron microscope or an optical microscope. Preferably, the image generation part includes a scanning electron microscope since the image is to be magnified with high magnifications.

The analysis apparatus includes a data generation part. The data generation part converts a space-domain signal into a frequency-domain signal by employing the FFT method. Thus, data having a frequency is generated from the image in the data generation part.

The analysis apparatus also has a data discrimination part for analyzing the generated data. The generated data are analyzed with the data discrimination part, thereby determining whether the region of the sample to be analyzed is normal or abnormal. The data discrimination part preferably includes a microprocessor having a program for achieving analysis of the sample.

The analysis apparatus further includes a display part and an alarm part. The display part displays the data that is generated in the data generation part, and the alarm part is controlled by the data discrimination part to give an alarm when the region of the sample is determined to be abnormal. Thus, with the display part, the operator can instantly identify whether the region of the sample is normal or abnormal, and additionally, with the alarm part, the operator can be immediately notified by an alarm when the region of the sample is abnormal. As a result, the operator can cope practically with a problem generated from the abnormal region.

As described above, the present invention provides an automated apparatus and method for analyzing a sample. In particular, the sample may be analyzed easily with a simple algorithm because the apparatus that analyzes the sample does so by employing a Fast Fourier Transformation technique in accordance with the method for analyzing a sample of the present invention.

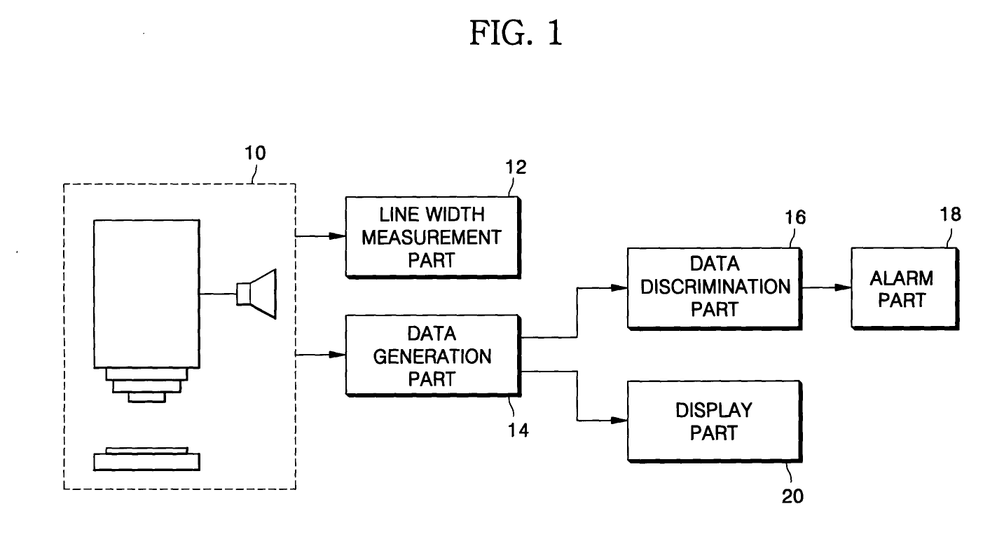

FIG. 1 is a block diagram illustrating an apparatus for analyzing a sample according to a preferred embodiment of the present invention.

Referring to FIG. 1, an analysis apparatus has a scanning electron microscope 10. The scanning electron microscope 10 is used to enlarge, for example, a minute pattern formed in a cell region of a semiconductor substrate to obtain a magnified image thereof.

The analysis apparatus includes a line width measurement part 12 for measuring the line width of the minute pattern in the magnified image. In this case, the line width measurement part 12 can automatically measure the line width of the minute pattern.

The analysis apparatus may further include a data generation part 14 and a data discrimination part 16. In the data generation part 14, a FFT is performed on data obtained from the magnified image to thereby generate frequency data. The generated frequency domain data is analyzed in the data discrimination part 16 to determine whether or not the minute pattern is normal. Therefore, it is possible to analyze and determine from the magnified image whether the minute pattern is normal or abnormal in the analysis apparatus by using the data generation part 14 and the data discrimination part 16. Namely, the analysis apparatus, rather than the naked eye of an operator, is used to automatically identify whether or not particles are adhered to the minute pattern. Further, the analysis apparatus of the present invention makes it possible to measure the line width of the minute pattern while simultaneously identifying the presence of any abnormalities in the minute pattern.

The analysis apparatus may further include a display part 20 and an alarm part 18. The display part 20 displays the data obtained from the data generation part 14, and the alarm part 18 sounds an alarm when the minute pattern is abnormal. The data obtained are indicated as a graph. Thus, the operator can identify at any time through the display part 20 whether or not the minute pattern is normal. When the minute pattern is abnormal, such as when the minute pattern falls down or a particle is adhered to the minute pattern, the data from the data discrimination part 16 indicates an abnormal minute pattern causing an alarm signal in the alarm part 18. As a result, the operator can immediately take action to solve the problem caused by the abnormal pattern. Additionally, the display part 20 displays a power spectrum of the data, so that the operator can identify the analyzed data without delay.

Hereinafter, a method for analyzing a sample using the analysis apparatus in FIG. 1 will be described.

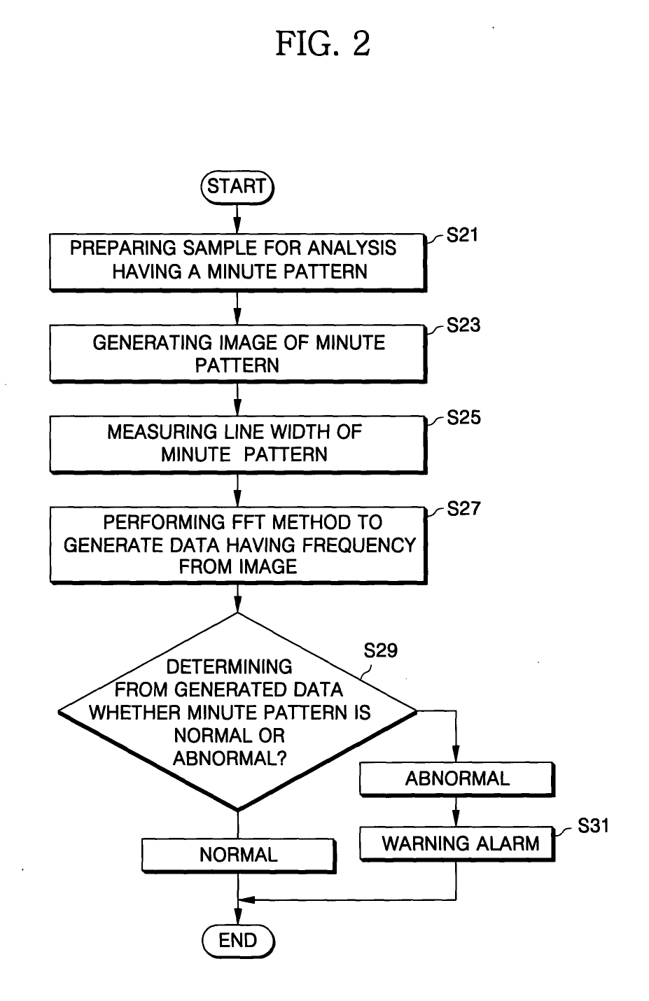

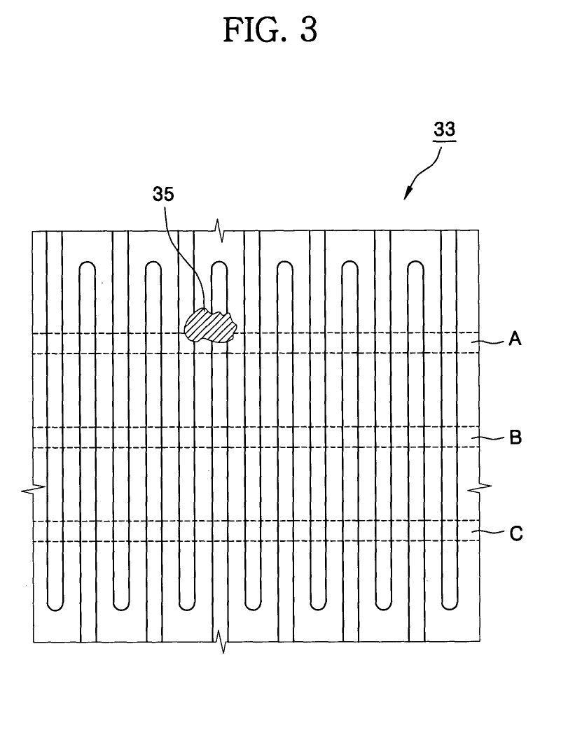

FIG. 2 is a flow chart illustrating the method for analyzing a sample according to a preferred embodiment of the present invention; and FIG. 3 illustrates a plane view showing a minute pattern included in a sample for analysis according to the present invention.

Referring to FIG. 2, a sample having a minute pattern is prepared for analysis (step S21). In this case, the minute pattern is formed by a photolithography process and is positioned in the cell region of a semiconductor substrate. Thus, the minute pattern has a periodically repeating shape.

Then, an image of the minute pattern is enlarged using a scanning electron microscope (step S23). Hence, a magnified image 33 of the minute pattern is obtained as shown in FIG. 3.

Using the magnified image 33 of the minute pattern, the line width of the minute pattern is measured (step S25). Simultaneously, the space-domain data of the magnified image 33 is converted into frequency-domain data through the FFT method (step S27). Subsequently, the frequency-domain data is analyzed to determine whether the minute pattern is normal or abnormal (step S29). If it is determined that the minute pattern is abnormal, a warning alarm is generated (step 31).

FIG. 3 illustrates a magnified image 33 of a minute pattern having lines ‘A’, ‘B’, and ‘C.’ Patterns positioned in lines ‘B’ and ‘C’ are normal, but a pattern positioned in line ‘A’ is abnormal, having a particle 35 adhered to it.

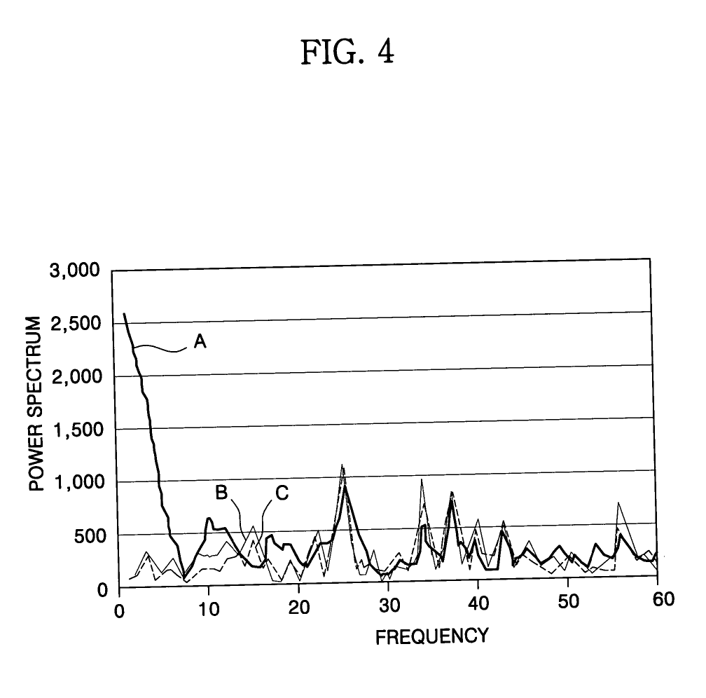

FIG. 4 is a graph illustrating power spectrums relative to frequency taken along the lines ‘A’, ‘B’, and ‘C’ shown in FIG. 3. Here, the power spectrums were obtained through the FFT method. In addition, the power spectrums indicate gray levels that are obtained by the Fast Fourier Transformation method using images respectively generated from the pixels positioned in the lines of ‘A’, ‘B’ and ‘C’ shown in FIG. 3, each of which is parallel to the X-axis direction.

FIG. 4 illustrates the power spectrums of the normal patterns in the lines ‘B’ and ‘C.’, which are nearly constant in both a low frequency band and a high frequency band. Also, the power spectrums are practically identical to each other because the patterns have similar shapes. However, the abnormal pattern positioned in line ‘A’ of FIG. 3, to which the particle 35 is adhered, has a power spectrum including an abnormal peak in the low frequency band. Thus, a region of a pixel where the abnormal pattern is positioned can be determined by identifying the region of the pixel corresponding to the position at which the abnormal peak is generated.

Determination of the abnormal pattern can be instantly and automatically performed using a microprocessor capable of analyzing the peak of the power spectrum. When the minute pattern is determined to be abnormal, the data discrimination part 16 controls the alarm part 18 to give the alarm (step S31). Therefore, once an operator identifies the abnormal pattern in accordance with the alarm generated from the alarm part 18, the operator can instantly take action toward solving the problem concerning the abnormal pattern.

While the FFT method has previously been used for measurement and analysis of samples, the FFT method has not been employed as in the present invention concerning automatic measurement and analysis of a minute pattern. Furthermore, the FFT method has not been used to identify an abnormal portion of a sample by analyzing a single image of the portion of the sample as in the present invention. Rather, other FFT measurement and analysis methods need the data of an additional reference sample to analyze and measure a sample. That is, samples are measured and analyzed by comparing the data of the additional reference sample with the data of a sample to be measured and analyzed.

As previously stated, it is possible to conveniently and automatically measure and analyze a sample using the apparatus of the present invention in accordance with the method of the present invention without the use of an additional reference sample. That is, in the present invention, a sample can be advantageously analyzed by identifying an abnormal portion of the sample from a single image of the sample using the FFT method.

As described above, according to the present invention, it is possible to determine whether a portion of a sample to be analyzed such as a minute pattern is normal or abnormal by employing the FFT method. Thus, whether a portion of a sample is normal or abnormal can be advantageously determined in accordance with the automatically constructed analysis apparatus and method of the present invention. In particular, the method and apparatus of the present invention are employed to measure the line width of the minute pattern and to simultaneously determine whether the minute pattern is normal or abnormal. Further, the method and apparatus of the present invention perform the aforementioned tasks automatically and without the assistance of an operator. As a result, the productivity and reliability of a semiconductor device may be improved.

Having described the preferred embodiments for measuring and analyzing the sample including the minute pattern, it is noted that modifications and variations can be made by persons skilled in the art in light of the above teachings. It is therefore to be understood that changes may be made in the particular embodiment of the present invention disclosed which is within the scope and the spirit of the invention outlined by the appended claims.

What is claimed is:

1. A method for analyzing a sample by employing a Fast Fourier Transformation method, comprising:
generating an image of a region of the sample to be analyzed;
generating data having a frequency from the image by the Fast Fourier Transformation method; and
analyzing the generated data to determine whether the region is normal or abnormal.

2. The method for analyzing a sample by employing a Fast Fourier Transformation method as claimed in claim 1, wherein the region includes a periodically formed pattern.

3. The method for analyzing a sample by employing a Fast Fourier Transformation method as claimed in claim 1, wherein the region is formed on a semiconductor substrate and corresponds to a cell region including a periodic pattern.

4. The method for analyzing a sample by employing a Fast Fourier Transformation method as claimed in claim 3, wherein the periodic pattern has a line width and is formed by an etching process.

5. The method for analyzing a sample by employing a Fast Fourier Transformation method as claimed in claim 1, wherein the image is generated by a scanning electron microscope.

6. The method for analyzing a sample by employing a Fast Fourier Transformation method as claimed in claim 1, further comprising defining the image into at least two pixel units.

7. The method for analyzing a sample by employing a Fast Fourier Transformation method as claimed in claim 1, further comprising providing an alarm when the region is abnormal.

8. A method for analyzing a sample by employing a Fast Fourier Transformation method, comprising:
generating a magnified image of a minute pattern formed in a cell region of a semiconductor substrate;
measuring a line width of the minute pattern using the magnified image;
generating data having a frequency from the image by the Fast Fourier Transformation method; and
analyzing the generated data to determine whether the minute pattern is normal or abnormal.

9. An apparatus for analyzing a sample by employing a Fast Fourier Transformation method, comprising:
an image generation part for generating an image of a region of the sample to be analyzed;
a data generation part for generating data having a frequency from the image by the Fast Fourier Transformation method; and
a data discrimination part for analyzing the generated data to determine whether the region is normal or abnormal.

10. The apparatus for analyzing a sample by employing a Fast Fourier Transformation method as claimed in claim 9, wherein the image generation part includes a scanning electron microscope.

11. The apparatus for analyzing a sample by employing a Fast Fourier Transformation method as claimed in claim 9, further comprising a display part for displaying the generated data.

12. The apparatus for analyzing a sample by employing a Fast Fourier Transformation method as claimed in claim 9, further comprising an alarm part for providing an alarm when the region is abnormal.

13. An apparatus for analyzing a sample by employing a Fast Fourier Transformation method, comprising:
a scanning electron microscope for generating a magnified image of a minute pattern formed in a cell region of a semiconductor substrate;
a line width measurement part for measuring a line width of the minute pattern using the magnified image;
a data generation part for generating data having a frequency from the magnified image by the Fast Fourier Transformation method; and
a data discrimination part for analyzing the generated data to determine whether the minute pattern is normal or abnormal.
